(19) United States
(12) Patent Application Publication
(10) Pub. No.: US 2007/0245398 A1
(43) Pub. Date: Oct. 18, 2007

(54) Universal parental control

(75) Inventor: Barbara Roden, Atlanta, GA (US)

Correspondence Address: POTOMAC PATENT GROUP PLLC, P.O. BOX 270, FREDERICKSBURG, VA, 22404, US

(73) Assignee: BellSouth Intellectual Property Corporation, Wilmington, DE (US)

(21) Appl. No.: 11/402,790

(22) Filed: Apr. 12, 2006

(51) Int. Cl. H04N 7/10; H04N 7/025; H04N 5/445

(52) U.S. Cl. 725/133; 725/34; 725/35; 725/46; 725/141; 725/153

(57) ABSTRACT

Systems and methods according to the present invention address this need and others by providing methods of controlling media content access through a universal control device that is linked to a plurality of consumer electronic devices in a common environment.

### BACKGROUND

Technologies associated with the communication of information have evolved rapidly over the last several decades. Television, cellular telephony, the Internet and musical electronics (such as CD players and MP3 devices), to name a few, combine to inundate consumers with available information and entertainment options. These electronic devices typically operate within a particular environment, e.g., the home of a user, however, they often function independently of one another. For example, a user will typically individually configure consumer electronic devices to enable them to perform various functions in the particular manner desired by the user.

The technological ability to provide so much information and content to end users provides both opportunities and challenges to those wishing to control media content accessibility. For example, parents may wish to restrict their children from being able to access media having certain content or from being able to access certain services altogether. Similarly, educators may wish to restrict access by students to media. As technology advances it can be expected that there will be more consumer electronic devices for delivering media to people, which further complicates this issue. For each device that is capable of displaying media, the user must manually set the device with the desired parental controls if the device supports such an ability. For example, a user may set a DVD player to not play R rated media and also set a CD player to not play media with explicit lyrics. Furthermore, if the content control is title specific, then the user must individually tell each device capable of playing the title, that it should not be played. For example, a parent may not want a particular movie to be shown and must program each movie playback device to indicate this restriction.

Another common method for allowing a parent to control content exposure in a television is through the use of a so called “V-chip”. Some televisions come with “V-chip” circuitry in the unit, which allows a parent to program what content is allowable to be viewed on that television. Content could be characterized either by the rating of the show, for example, G, PG-13 or R, or the content could be characterized by a description, such as, sexual content or violence. The “V-chip” then acts as a filter for incoming television content by comparing the content characterization of the incoming program to the rules programmed into the “V-chip”, and either passing or blocking the signal based on the results of the comparison.

Yet another specific area of concern for media control, is the content available from surfing the Internet. Currently a variety of programs can be purchased that allow a parent to set up controls for blocking content or access to a variety of web sites.

Given the increasing number of media delivery devices and the increasing amount of available content, control of access to content is becoming a difficult chore. Therefore, there is a need for a universal content control method that allows a single device or system to control the content output from all consumer electronic devices in the user's environment.

### SUMMARY

Systems and methods according to exemplary embodiments address this need and others by providing techniques for universal content control to control the content output from all (or a subset of) consumer electronic devices in the user's environment.

According to one exemplary embodiment, a universal content control device for controlling media content access comprising an input for receiving input associated with media content access rules, a processor for associating media content access rules with different types of consumer electronic devices based on the capabilities of consumer electronic devices and an output for transmitting associated media content and access instructions to different types of consumer electronic devices for controlling content access at the consumer electronic devices.

According to another exemplary embodiment, a method for distributing media content access rules comprising the steps of receiving input associated with media content access rules, associating media content access rules with different types of consumer electronic devices based on the capabilities of consumer electronic devices and transmitting associated media content and access instructions to different types of consumer electronic devices for controlling content access at the consumer electronic devices.

According to another exemplary embodiment, a system for distributing media content access rules includes a universal content control device for receiving input associated with the media content access rules, a plurality of consumer electronic devices, wherein the consumer electronic devices interact with media based on media content access instructions received from the universal content control device, and communication links connecting the universal content control device to the plurality of consumer electronic devices, wherein the universal content control device further includes an input for receiving input associated with the media content access rules, a processor for associating said media content access rules with different types of consumer electronic devices based on the capabilities of the consumer electronic devices, and an output for transmitting the associated media content and access instructions to the plurality of consumer electronic devices for controlling content access at the consumer electronic devices.

### BRIEF DESCRIPTION OF THE DRAWINGS

The accompanying drawings illustrate exemplary embodiments of the present invention, wherein:

FIG. 1 illustrates an exemplary environment with multiple consumer electronic devices in which exemplary embodiments can be employed;

FIG. 2 illustrates an exemplary environment with a universal content control device according to exemplary embodiments;

FIG. 3 shows details of a universal content control device according to exemplary embodiments;

FIG. 4 shows an interface screen for a universal content control device according to exemplary embodiments;

FIG. 5 is a flowchart describing a method for distributing media content access rules according to exemplary embodiments;

FIG. 6 is a flowchart describing the processing of content rules by a universal content control device according to exemplary embodiments.

### DETAILED DESCRIPTION

The following detailed description refers to the accompanying drawings. The same reference numbers in different drawings identify the same or similar elements. Also, the following detailed description does not limit the invention. Instead, the scope of the invention is defined by the appended claims.

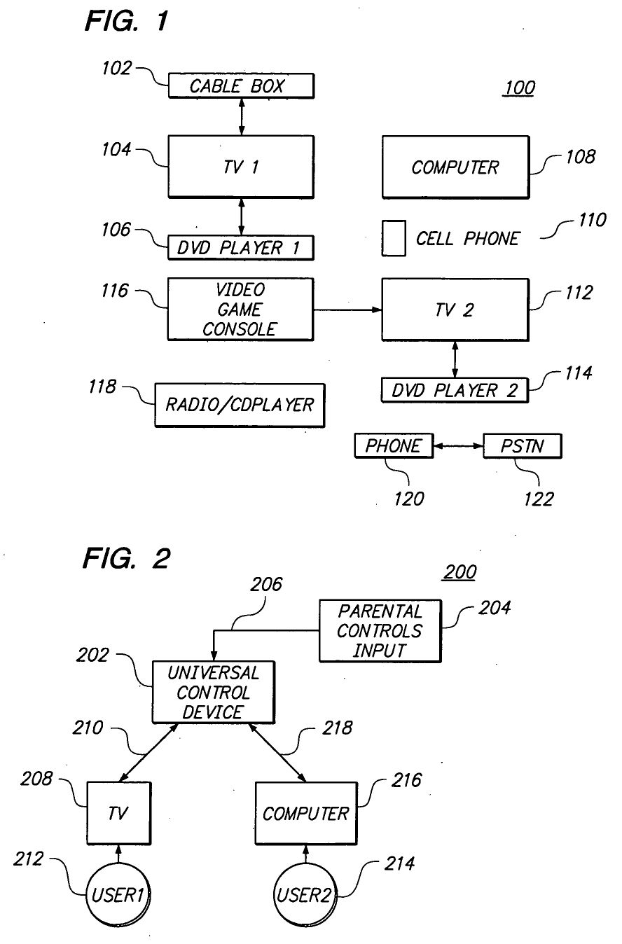

In order to provide some context for this description, an exemplary environment in which exemplary embodiments can be employed will now be described with respect to FIG. 1. FIG. 1 shows an environment 100, such as a household or a classroom, within which there are a multitude of consumer electronic devices, such as cable box 102, TV1 104, DVD player1 106, computer 108, cell phone 110, TV2 112, DVD player2 114, video game console 116, radio/CD player 118, phone 120 hooked up to the publicly switched telephone network (PSTN) 122. In this environment, some of the consumer electronic devices are capable of communicating with each other, such as TV2 112 and DVD player2 114, while other devices are stand alone, such as cell phone 110. Additionally, each of these consumer electronic devices has the capability to receive external media inputs as well as commands. For example, the computer 108 can interface with the Internet (not shown) and cable box 102 receives data from the cable head-end via coax cable. According to exemplary embodiments, all of these devices (or any desired subset) may be universally programmed with controls to selectively permit or block various content.

To simplify the discussion, an exemplary home environment 200 with only two consumer electronic devices that are universally programmed with parental controls will now be described with respect to FIG. 2. It should be appreciated, however, that the invention is not limited to implementation in a home or control by a parent. Rather, the environment of communication devices may include any environment over which control is needed, such as a classroom, prison, corporation, etc., and the control may be provided by any party seeking to control access to content by the communication devices. According to the exemplary embodiment shown in FIG. 2, a universal control device, referred to for illustrative purposes as a universal control device 202, contains content and access rules regarding how consumer electronic devices interact with external media. External media in this context refers to any media that can be accessed by the user of a consumer electronic device. For example, TV programs, DVD's and internet content, among other things, would all be considered external media for purposes of this specification. Note that the universal control device 202 may be physically located in the network or within the home, e.g., as part of the computer 216 or home router (not shown).

Initially, a parent can enter content and access rules from parental controls input device 204, and communicate these rules via communication link 206 to the universal control device 202. Parental controls input device 204 can take many different forms, an example of which is given below with respect to FIG. 4. After various processing and/or formatting of the input, described below, universal control device 202 then communicates the relevant content and access rules to both TV 208 and computer 216 via communication links 210 and 218, respectively. In this way, when user1 212 or user2 214 activate either TV 208 or computer 216 media displayed or heard will be permitted as long as the media meets the content and access rules. The parent need not individually program each device with the parental controls. It is understood that while this exemplary embodiment only illustrates an environment with two consumer electronic devices in the household environment 200, that there could be up to n different consumer electronic devices each linked to the universal control device 202. Additionally access rules could describe how much time per day a user was allowed to use either a single device, or all of the devices together, or any subset thereof.

According to one exemplary embodiment a single common content and access rule list (or set of characteristics) is input into the universal control device 202. This content and access rule list is then processed using logic within the universal control device 202 to create specific instructions for each relevant consumer electronic device in the household environment 202. These specific instructions may be generated by selection and formatting within the universal control device 202 and are then passed on to the relevant consumer electronic device(s). For example, suppose that parental input is received by the universal control device 202 that states no R rated content is to be output from those devices associated with this parental control input or device list (described below). The universal control device 202 would then send more specific instructions to TV 208, using a format and a communication link which are compatible with TV 208, that would not allow any media that has a content rating of R or higher to be displayed or heard. The universal control device 202 would also send more specific instructions to computer 216 that would not allow any media that has a content rating of R or higher to be displayed or heard nor allow access to internet sites with content considered R equivalent or higher.

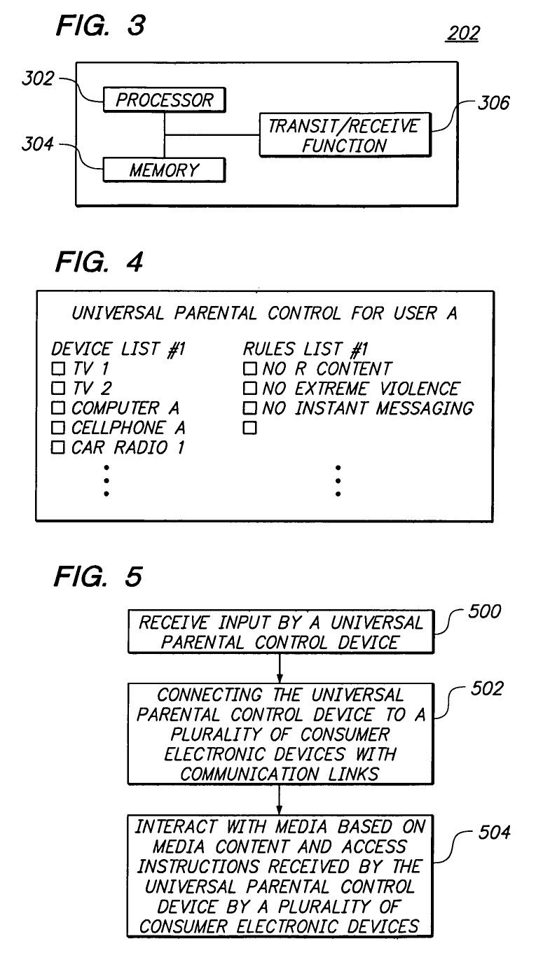

An exemplary universal content control device, such as the universal control device 202 is shown in FIG. 3 and contains a processor 302, memory 304 and a transmit/receive function 306, all of which are linked together. The universal control device 202 may reside locally with respect to a single set of consumer electronic devices or may reside at a network center. The processor 302 and memory 304 are used to process and store content and access rules, as well as instructions regarding how these rules are to be implemented. Input to the universal control device 202 is received from the parental controls input 204. The parental controls input 204 can also be part of the universal control device 202. The communication links 206, 210 and 218 can be any type of wire or wireless connection used for transmitting information.

As mentioned earlier, the universal control device 202 takes the inputs from parental control input device 204 and applies selection and formatting processes to generate a set of content and access control commands for that particular user's set of consumer electronic devices. For example, according to one exemplary embodiment of the present invention, the parental control input device 204 can be a web portal accessible via the parent's home computer. The web portal may provide a user interface screen such as that shown in FIG. 4. Therein, a first list of devices which have been registered with the universal control device 202 for a particular parent (User A) are shown on the lefthand side of the screen, while a high level list of rules are shown on the righthand side of the screen. The user can select which devices to include in list #1 via the checkboxes on the righthand side of the screen. For example, if the user is a parent of a teenager that has access to TV1, Computer A and car radio 1, but not cellphone A or TV2, then he or she could check the boxes next to TV1, Computer A and car radio 1 such that rules list #1 could be tailored to control the content which would be output by devices available to that child, without applying the same rule set to other devices. Similarly, the user can select (or deselect) rules which are applicable to this list of devices using the checkboxes on the lefthand side of the screen. Each user can have multiple device lists associated with their parental control account to enable them to control groups of devices within their environment in different ways. For additional flexibility this exemplary system could also be setup to allow controls to be input or overridden from an external communication device like a cell phone if the user had the right level of access.

According to another exemplary embodiment, the universal control device 202 can have settings that allow a device to be shared by multiple users wherein the controls for the shared device are set in accordance to the parent's rules. For example, if there are two non-parental users in the household, both users will have rules associated with them in addition to rules for the devices. This would allow, for example, a teenage child and 5 year old to share the same device with the device set to the content control rules of the person actually using the device. To manage this feature, each user can be given a login/password so that the appropriate rules set is applied to the person actually using a device.

Given this input information, the universal control device 202 can use selection techniques programmed into processor 302 and/or memory 304 to implement the selected rules list across those relevant devices in list #1. For example, if the parent selected no instant messaging as a rule for this device list, then the universal control device 202 would generate suitable specific instructions only to those devices in the list which have instant messaging capability, e.g., computer A and/or cellphone A, but not to those devices on the list which do not have instant messaging capability, e.g., TV 1. This feature of exemplary embodiments saves the user time by allowing universal controls to be implemented across devices having overlapping, but not identical, capabilities and corresponding parental controls. A list of exemplary parental controls/rules which can be provided as selectable options in the user interface of FIG. 4 is provided below, but is by no means exhaustive. Some examples of exemplary parental controls are as follows: no R content, no extreme violence, no instant messaging, no explicit lyrics and no sexual content.

According to exemplary embodiments as illustrated in FIG. 5, a method for distributing media access rules includes a number of different steps including: receiving input associated with media content access rules by a universal content control device, such as a parental control device (step 500); connecting the universal content control device to a plurality of consumer electronic devices with communication links (step 502); and interacting with media based on media content and access instructions received from the universal content control device by a plurality of consumer electronic devices (step 504). Again, although the steps shown in FIG. 5 refer to interactions with a parental control device, it should be appreciated that they are also applicable to any type of content control devices.

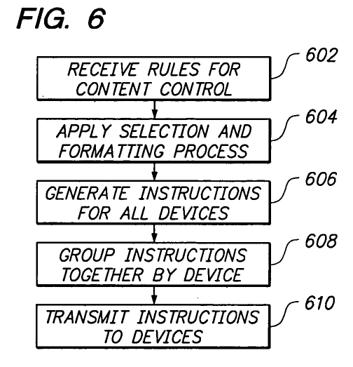

According to an exemplary embodiment the steps performed by an exemplary universal content control device are shown in the flowchart of FIG. 6. Initially, the universal content control device receives rules for content control (step 602). These rules then undergo a selection and formatting process (step 604) is applied, e.g., based on the type(s) of consumer electronic devices to be controlled by this particular universal content control device. The output from the selection and formatting process is a set of instructions (step 606) for all consumer electronic devices in communication with the universal content control device. These instructions are grouped together by device (step 608), which may result in different consumer electronic devices receiving a different number of instructions, e.g., when certain rules do not apply to certain types of consumer electronic devices. Then the instructions are transmitted by the content control device to the consumer electronic devices (step 610) using, e.g., an appropriate format and communication link.

According to another exemplary embodiment the user accesses a device in, for example, the household environment through either a unique identification number or an electronic card. The system would then only allow access and content according to rules that correspond to that user. These rules would be predetermined in the content control unit. Alternatively, the rules could be embedded on the electronic card.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A universal content control device for controlling media content access comprising:
an input for receiving input associated with said media content access rules;
a processor for associating said media content access rules with different types of consumer electronic devices based on the capabilities of said consumer electronic devices; and
an output for transmitting said associated media content and access instructions to said different types of consumer electronic devices for controlling content access at said consumer electronic devices.

2. The device of claim 1, wherein said universal control device further comprises a memory and a transmit/receive function.

3. The device of claim 2, wherein said memory contains rules for content and access of said media.

4. The device of claim 3, wherein a common rules list is applied to all consumer electronic devices.

5. The device of claim 3, wherein a separate rules list exists for each type of consumer electronic device.

6. The device of claim 1, wherein said consumer electronic devices include one or more of TVs, DVD players and computers.

7. The device of claim 1, wherein media is a displayable visual output or an auditory output.

8. The device of claim 2, wherein said processor selects rules stored in said memory based on said input by matching said input to relevant ones of plurality of consumer electronic devices having corresponding capabilities and further wherein said processor formats said selected rules into a data format which is compatible with respective ones of said plurality of consumer electronic devices.

9. A method for distributing media content access rules comprising the steps of:
receiving input associated with said media content access rules;
associating said media content access rules with different types of consumer electronic devices based on the capabilities of said consumer electronic devices; and
transmitting said associated media content and access instructions to said different types of consumer electronic devices for controlling content access at said consumer electronic devices.

10. The method of claim 9, wherein said universal control device includes a processor, memory and a transmit/receive function.

11. The method of claim 9, further comprising the step of:
storing rules for content and access in said universal control device.

12. The method of claim 11, further comprising the step of:
applying a common rules list for all consumer electronic devices associated with said universal control device.

13. The method of claim 11, further comprising the step of:
applying a separate rules list for each type of consumer electronic device associated with said universal control device.

14. The method of claim 9, wherein said consumer electronic devices include one or more of TVs, DVD players and computers.

15. The method of claim 9, wherein said displayed visual output or emitted auditory output is media.

16. The method of claim 8, wherein said step of receiving input associated with said media content access rules by a universal control device further comprises the step of:
creating content access rules for said plurality of consumer electronic devices through selection and formatting of said input.

17. The method of claim 10, wherein said processor selects rules stored in said memory based on said input by matching said input to relevant ones of plurality of consumer electronic devices having corresponding capabilities and further wherein said processor formats said selected rules into a data format which is compatible with respective ones of said plurality of consumer electronic devices.

18. A computer-readable medium containing instructions which, when executed on a universal content control device, performs the steps of:
receiving input associated with said media content access rules;
associating said media content access rules with different types of consumer electronic devices based on the capabilities of said consumer electronic devices; and
transmitting said associated media content and access instructions to said different types of consumer electronic devices for controlling content access at said consumer electronic devices.

19. A system for distributing media content access rules comprising:
a universal content control device for receiving input associated with said media content access rules;
a plurality of consumer electronic devices, wherein said consumer electronic devices interact with media based on media content access instructions received from said universal content control device; and
communication links connecting said universal content control device to said plurality of consumer electronic devices,
wherein said universal content control device further includes:
an input for receiving input associated with said media content access rules;
a processor for associating said media content access rules with different types of consumer electronic devices based on the capabilities of said consumer electronic devices; and
an output for transmitting said associated media content and access instructions to said plurality of consumer electronic devices for controlling content access at said consumer electronic devices.
